(19) United States
(12) Patent Application Publication
(10) Pub. No.: US 2005/0196266 A1
(43) Pub. Date: Sep. 8, 2005

(54) Device and method for unpacking wrapped articles

(75) Inventor: Gerhard Kropp, Bremen (DE)

Correspondence Address: FULBRIGHT & JAWORSKI, LLP, 1301 MCKINNEY, SUITE 5100, HOUSTON, TX, 77010-3095, US

(73) Assignee: Heino Ilsemann GmbH, Bremen (DE)

(21) Appl. No.: 11/057,265

(22) Filed: Feb. 14, 2005

(30) Foreign Application Priority Data
Feb. 13, 2004 (DE) 102004007488.7

(51) Int. Cl. B65G 59/02

(52) U.S. Cl. 414/797

(57) ABSTRACT

A device for unwrapping wrapped stacks of articles and an associated method. The method includes the steps of: preparing a pallet with block-like stacks of flat articles stacked thereon in layers, each wrapped in a film-like wrapper. A stack is located, especially within a pallet layer at the very top; lowering a lifting head onto an upper side of the stack; grasping a portion of the wrapper associated with the upper side with the lifting head and removing the stack and depositing it at an unwrapping station. Thereafter, grasping and raising the portion of e wrapper with two grabs in two spaced-apart grabbing positions; cutting through the portion of the wrapper between the grabbing positions; opening the wrapper with the grabs; grasping the stack while the wrapper is held tight by the grabs; depositing the stack at a delivery position, and removing the wrapper and also a device suitable for this purpose.

### CROSS-REFERENCE TO RELATED APPLICATIONS

This application claims priority to DE 102004007488.7 filed Feb. 13, 2004.

### TECHNICAL FIELD

The invention relates to a method and device for unpacking wrapped stacks of articles.

### BACKGROUND OF THE INVENTION

Wrapped stacks of articles in the context of the invention are block-like stacks consisting of a number of flat, especially rigid, slab-like articles with a rectangular outline, each individual stack being surrounded and held together by a film-like wrapper in such a way that it can be handled as a unit without the individual articles immediately becoming detached therefrom. The wrapper can be applied with tension, such as by being shrunk As a rule, it will be a wrapper formed from flat strips of from, in which, in the wrapped state, four outer surfaces of the stack lying perpendicular to a plane are covered by the wrapper, two outer surfaces opposite one another therefore not being covered. The invention can nevertheless still be used if the wrapper extends slightly round the opposing outer surfaces of the stack which are not wrapped per se.

The object of the invention consists in providing a method which is as automated as possible, and a corresponding device, for unpacking wrapped stacks of articles, so that time-consuming and costly manual activities for removing the wrapper can be dispensed with as far as possible.

### BRIEF SUMMARY OF THE INVENTION

In accordance with the invention, a method is provided for unpacking wrapped stacks of articles, comprising the steps of:
preparing a pallet with block-like stacks of flat articles stacked thereon in layers, each wrapped in a film-like wrapper,
locating a stack, especially within a pallet layer at the very top,
lowering a lifting head onto an upper side of the stack,
grasping a portion of the wrapper associated with the upper side with the lining head,
removing the stack and depositing it at an unwrapping station,
grasping and raising the portion of the wrapper with two grabs in two spaced-apart grabbing positions,
cutting through the portion of the wrapper between the grabbing positions,
opening the wrapper with the grabs,
grasping the stack while the wrapper is held tight by the grabs, and depositing the stack at a delivery position, and
removing the wrapper.

It is preferably provided that the stack is prepared in a position in which the flat articles are arranged side by side in a vertical position,

Grasping the portion of the wrapper with the lifting head can be effected by means of a partial vacuum or alternatively or in addition by means of clamping and gripping.

It is convenient for the grasping of the portion of the wrapper at the wrapping station to be effected by means of a partial vacuum or alternatively or in addition by means of clamping and gripping.

The portion of the wrapper is preferably cut through by a horizontally movable cutting knife, forming two free wrapper ends in the process. The wrapper ends can be moved apart in opposite directions with the grabs and the wrapper opened in this way before the stack is grasped and deposited.

It is convenient for the wrapper to be withdrawn by means of a partial vacuum and removed from the unwrapping station.

It is also preferably provided that an orientation of the stack is detected and the stack rotated before being deposited in a predetermined orientation.

Also in accordance with the invention, a device is provided for unpacking wrapped stacks of articles, comprising
lifting means for grasping and removing a block-like stack of flat articles wrapped in a film-like wrapper from a pallet,
unwrapping means having two separately movable grabs for grasping a portion of the wrapper at the top side of the stack at two spaced-apart grabbing positions, and having a cutting means for cutting through the portion of the wrapper between the grabbing positions, the grabs being controlled such that, after the portion of the wrapper baa been grasped and cut trough, they open the wrapper,
a delivery means for grasping and depositing the wrapper-free stack at a delivery position.

It is preferably provided for the lifting means to have a vacuum lifting head, which may have a perforated plate and an elastic sealing bead running along the edge thereof.

It may be appropriate for the lifting means to have a centering means with two photoelectric barriers working in directions perpendicular to one another for locating a corner of a pallet stack.

The grabs may each have a grab body and a gripping member movable relative thereto, one gripping surface of the grab body and gripping member having elevated static friction, in order to entrain the wrapper by means of friction and to clamp it between the gripping member and the grab body. For this purpose, the gripping surface may have elevated surface roughness. In order to ensure that the wrapper is entrained by the gripping surface of the grab body and of the gripping member and can be clamped between them, it may be appropriate for it to be possible for a partial vacuum to be applied to the gripping surface of the grab body and/or gripping member in addition.

It can be provided for the grabs to be capable of being swiveled in opposite directions in order to open the wrapper.

It is appropriate for the cutting means to have a horizontally movable cutting knife.

A useful embodiment is characterized by the fact that the unwrapping means has a vacuum suction extraction means for removing and disposing of the wrapper.

In addition, it may be provided for the delivery means to have a position recognition means for recognizing the orientation of a stack and a rotating means for rotating into a predetermined orientation.

### BRIEF DESCRIPTION OF THE DRAWINGS

Further advantages and features of the invention will become apparent from the following description of a working embodiment, reference being made to a drawing, in which:

FIG. 1 shows a top view of a device for unpacking wrapped stacks of articles,

FIG. 2 shows a side view of an unwrapping means of the device according to FIG. 1 looking in the direction of the arrow II in FIG. 1,

FIG. 3 shows a font end view of the unwrapping means according to FIG. 2 in the direction of the arrow III in FIG. 2,

FIG. 4 shows an enlarged partial view of the unwrapping means according to FIG. 2 with an indication of a stack of articles located therein,

FIG. 5 shows a representation corresponding to FIG. 4 to explain the process of grasping a portion of the wrapper, and

FIG. 6. shows a top view of the unwrapping means according to FIGS. 2 and 3.

### DETAILED DESCRIPTION OF THE INACTION

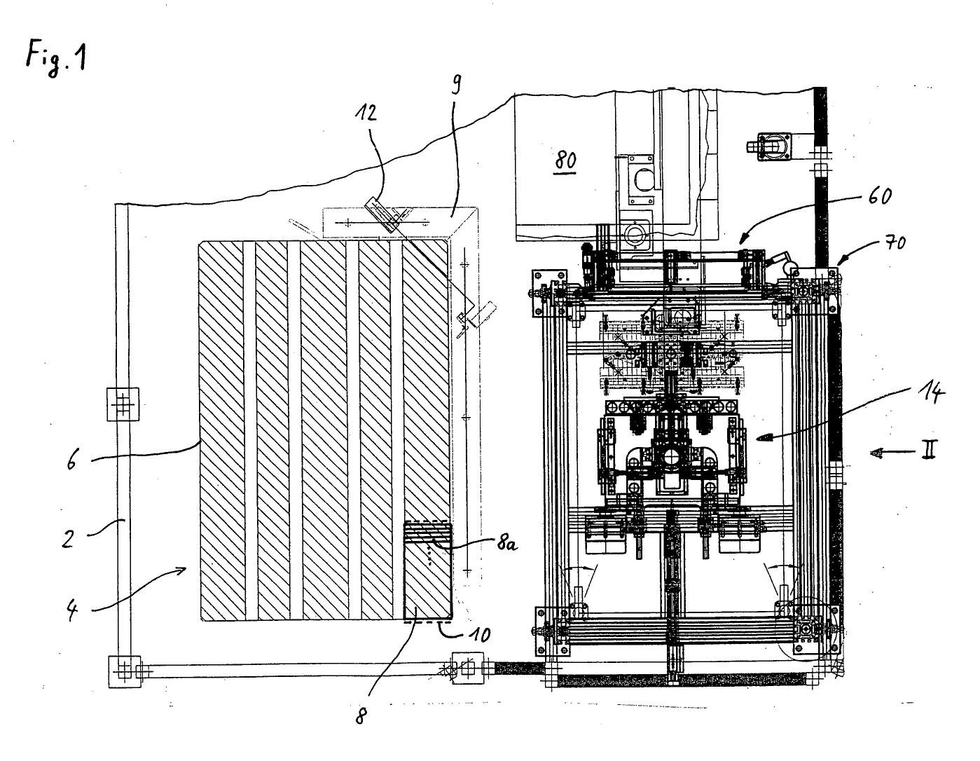

FIG. 1 shows a top view of a device of the invention for unpacking wrapped stacks of articles. Inside a safety encapsulation 2 of the machine there is a pallet store 4 with a pallet 6 thereon which is loaded wit block-like stacks of flat articles. A stack 8 of this kind is indicated in FIG. 1, each stack comprising a number of rigid, flat articles 8a, about 5, 10, 20 or more, such as packages for data or sound/video carriers, (CD or DVD packaging boxes).

The individual flat articles Ba (e.g. packaging boxes) are located inside the individual stacks in a vertical orientation as is indicated in FIG. 1, the individual articles being rectangular or square and being of relatively small thickness.

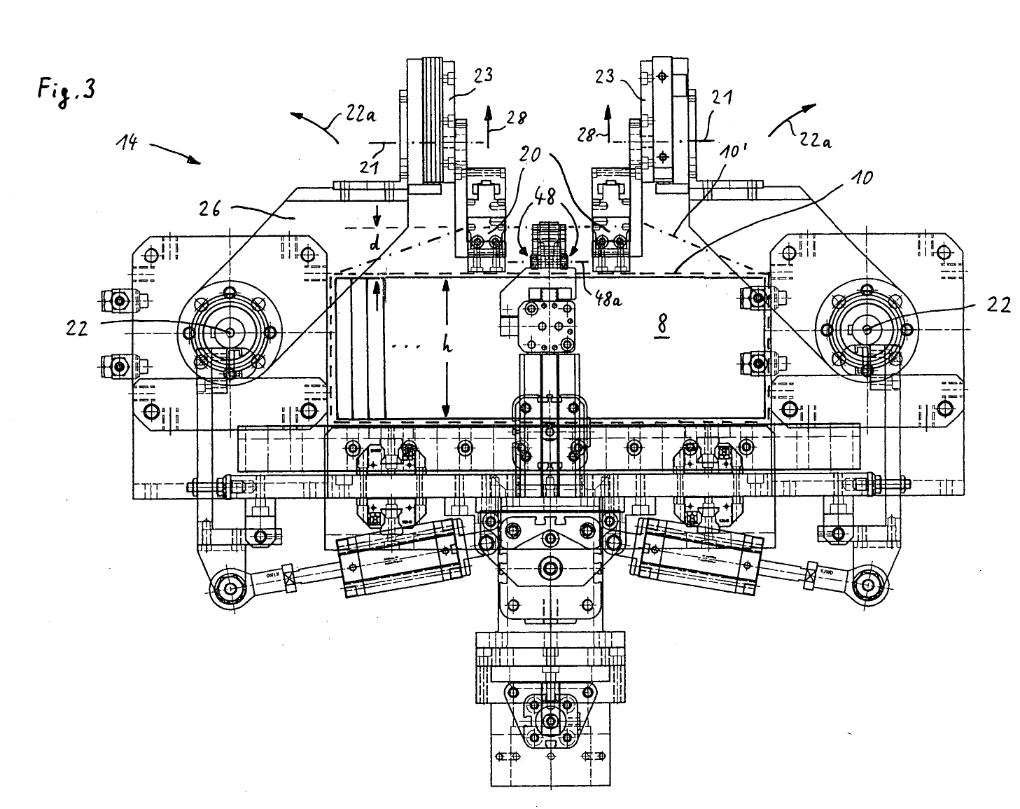

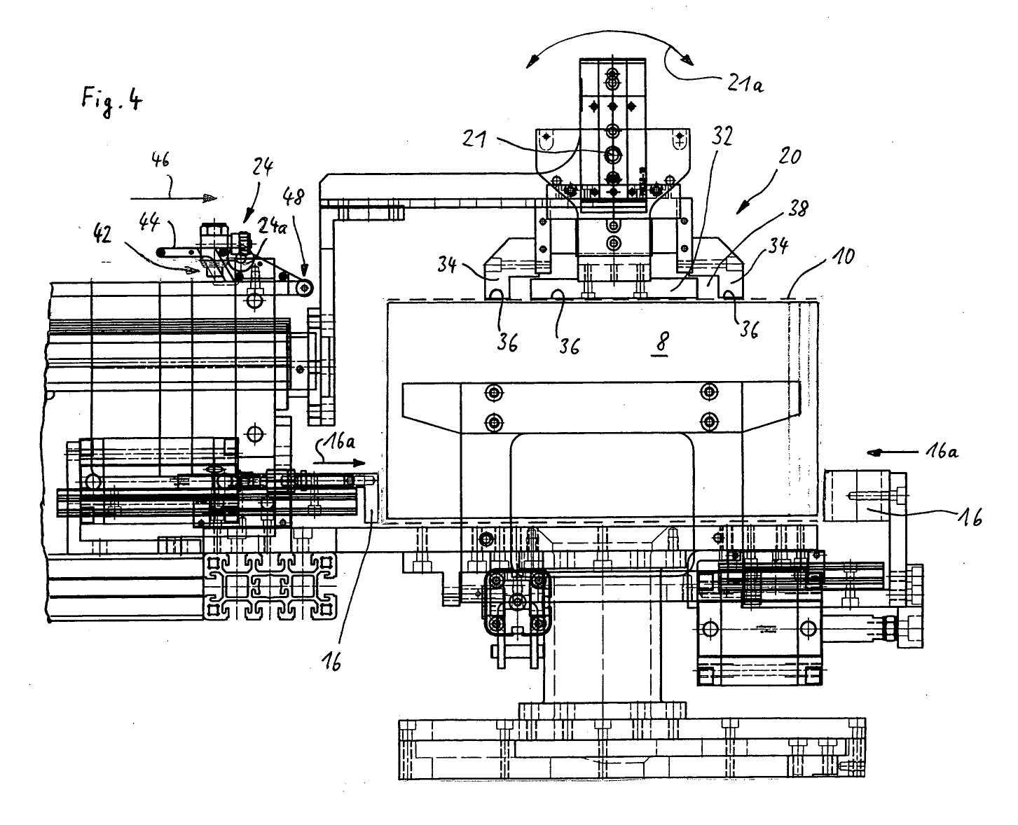

Each stack 8 is wrapped with a wrapper 10 (FIGS. 3, 4) in such a way that four alternating outer surfaces of the stack standing vertically on one another are wrapped, while the two remaining, mutually opposing outer surfaces are not wrapped. Considering FIG. 1, each stack 8 is wrapped in such a way that the upper and lower faces of the stack 8, parallel to the plane of he representation, and the front and rear end faces of the stack, at the top and bottom in FIG. 1, perpendicular to the plane of the representation in each case, are wrapped whereas the outer surfaces of the stack 8 arranged on the left and tight in FIG. 1, timing perpendicular to the plane of the representation, are not wrapped In this way, the wrapper exerts a tensioning force with its end-face portions, which presses the individual articles 8a together, so that the stack can be raised and manipulated by grasping an upper, flat portion of the wrapper, without individual articles sliding out.

A right-angled pallet-handling system 9 serves to deposit a loaded pallet in the pallet store 4 with a relatively small tolerance, a photoelectric barrier 12 detecting the presence of a loaded pallet.

A lifting means, which is not shown in detail, serves to grasp and remove a stack 8 from the pallet 6, the lifting means having a vacuum lifting head guided by a controlled manipulating robot, which lifting head can be lowered onto the stack to be removed, or onto the portion of the wrapper an its upper side, and firmly holds the portion of the wrapper by applying a vacuum to it, so that the stack can be raised and manipulated The lifting head has a rectangular base and comprise a flat perforated plate made of metal, generally rectangular in its overall shape and with rounded corners, with an elastic sealing bead made from a resilient material along the lower side of its edge. The perforated plate is enclosed at the top by a housing having a vacuum connection, so that a portion of the wrapper of the stack to be grasped which is located on the upper side of the stack, can be sucked against the perforated plate and grasped in this way.

In the region of the lifting head, there are disposed two photoelectric barriers operative in directions perpendicular to one another (e.g. X and Y), one pair in each case to detect one of two edges perpendicular to one another, in order to be able to locate a corner of the pallet load.

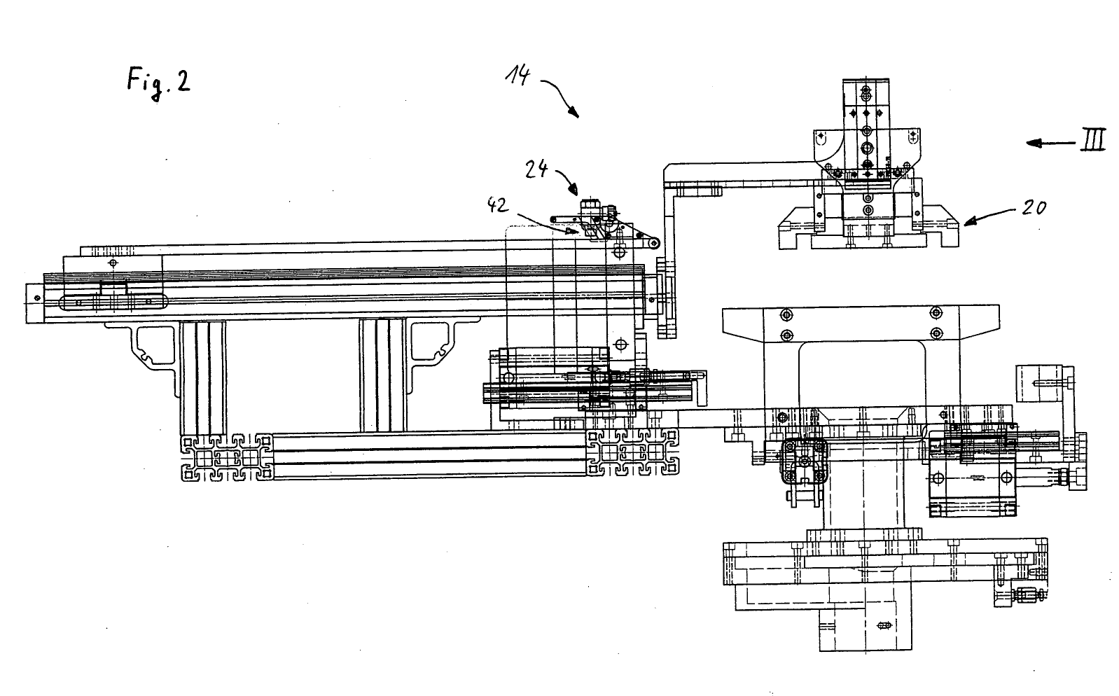

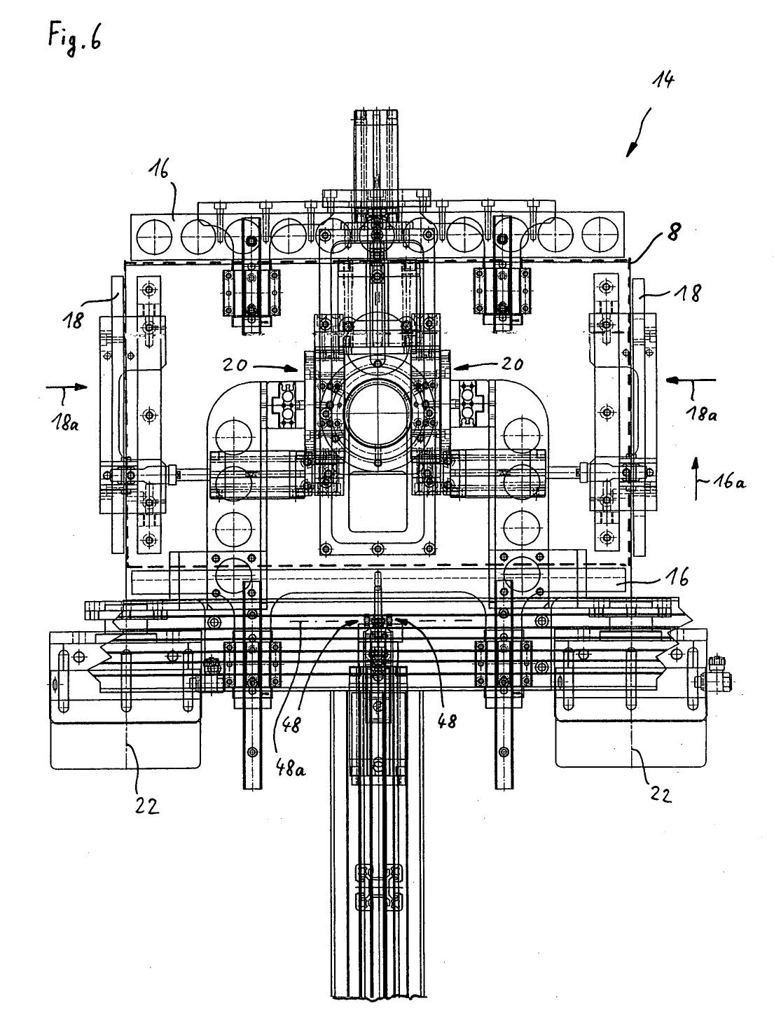

The lifting means is controlled such that the grasped stack can be deposited in the vicinity of an unwrapping means 14 by switching off the vacuum, said unwrapping means being shown in FIGS. 2 to 6 in different views. FIG. 6 shows a top view of the unwrapping means corresponding to FIG. 1 on an enlarged stale, a stack 8 deposited therein being shown by dashed

The unwrapping means 14 is shown in a side view in FIG. 2 and in a front-end view perpendicular thereto in FIG. 3, with first centering pushers 16 centering the stack 8 in a fist direction 16a after the stack has been deposited in a rough position and second centering pushers 18 centering the stack ina second direction 18a perpendicular thereto (FIG. 6).

Two grabs 20 are attached to swivel arms 26 so as to be pivotable about horizontal swiveling axes 22 with the object of raising the wrapper 10, once the stack has been centered, off the upper side of the stack by a distance d (FIG. 3) so that a horizontally movable cutting knife 24 (FIG. 4) can be moved between the wrapper and stack. In order to raise the wrapper, the grabs 20, in addition to the swiveling work about the swiveling axes 22 in the direction of the arrow 22a, are slidably movable to a certain extent, by 5% to 50% of the vertical dimension h of the stack 8 for example, in the vertical direction 28 relative to the swvel arms 26.

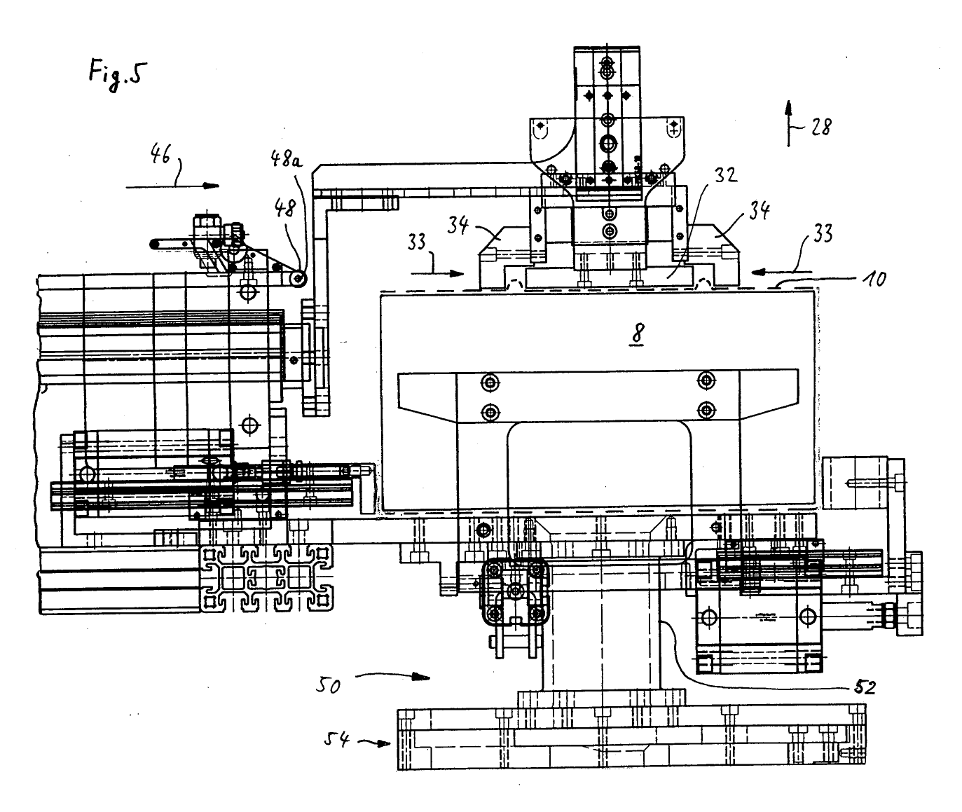

FIGS. 4 and 5 illustrate, on an enlarged scale, the structure of the grabs 20 and cutting knife 24 and the way they work In the representations of FIGS. 4 and 5 the individual articles of tile stack lie parallel to the plane of the representation and one behind the other in the direction perpendicular to the plane of the representation, while the wrapper reaches round the horizontal upper and lower sides of the stack, as indicated, and also the vertical facing ends of the stack above and below the plane of the representation.

The two grabs 20 each consist of one central grab body 32 and two grab members 34 attached symmetrically thereto on both sides, which are movable to and fro in a horizontal direction 33. On the underside, the grab body and grab members have a gripping surface 36 which, t s to an increased s o roughness, such as by mean of being coated with an appropriate material for example, possesses as great a static friction coefficient as possible. The gripping surface 36 may, for example, be laminated with emery paper.

As is indicated in FIGS. 3 and 4, the grabs 20 are in each case held so as to be capable of swiveling, in a free or floating manner, about a swiveling axis 21 relative to the swivel arms 26, so that each grab can, in its totality, perform an independent compensatory movement in the direction of the arrow 21a (FIG. 4). The purpose of this is to ensure that each grab 20 rests with as much of its planar gripping surface 36 as possible on the wrapper 10, even if the stack 8 of articles should for some reason or other be lying in the unwrapping means 14 in a tilted fashion or in some other way which is not horizontal. It might, for example, be the case that some of the flat articles in the stack become displaced relative to one another, so that the upper side of the stack is not flat and parallel to the deposition area of the unwrapping means. The possibility of swiveling about the axis 21 in a floating manner provides for a means of compensation here. In this working embodiment, the swiveling axis 21 is designed in the form of a swivel mount attached to a carriage 23, the carriage 23 being capable of traveling relative to the swivel arm 26 in the direction 28, in order to enable the grabs 20 to travel vertically into the swivel arm position shown in FIG. 3.

In the fully open position of the grabs 20, when the grab members 34 are moved completely outwards (FIGS. 4, 5), a space 38 is formed between each of the grab members 34 and the grab body 32. When the gripping surface 36 is lying on the wrapper 10 with a certain pressure, part of the wrapper. 10 can be dragged from its edge portions into the space 38, forming a slight arch (FIG. 5), by moving he grab members together in the direction of the arrows 33; once the grab members are fully closed, that part of the wrapper can be held tight by pinching it against the grab body. Following that, by raising the grabs (grab body with the two grab members) in direction 28, the wrapper 10 can be raised in the desired manner by moving the carriage 23, one possible position of the wrapper in the raised state being indicated in FIG. 3 by dashed dotted lines 10′.

In order to enhance the entraining capacity of the gripping surface 36 Still further, vacuum holes may be provided which lead to the gripping surface and fir improve the adhesion of the wrapper to the gripping surface during the closing movement of the grab members, so that a clamping and grasping in accordance with FIG. 5 is ensured.

The cutting knife 24 has a blade 42 mounted in a knife guide 24a, the cutting edge of which is disposed pointing in the withdrawal direction and obliquely inclined beneath a guard arm 44 which, when the cutting knife is moved back in the opposite direction to the direction of advance 46, reaches beneath and grasps the wrapper and guides it against the blade, which ensures that the wrapper is cut completely through by the blade.

Disposed in front of the blade 42 in the direction of advance 46 and spaced apart from one another are two guide rollers 48 capable of rotating about a horizontal axis of rotation 48a, which facilitate the process of advancing the cutting knife between the raised wrapper 10′ and the stack 8 and prevent the knife guide from penetrating the wrapper during its advance movement in direction 46. When the cutting knife is advanced filly forwards, the grabs release the wrapper, so that the latter is lowered and can be grasped by the guard arm and cut as the cutting knife travels back.

As FIG. 5 shows, a vacuum-suction extraction means 50 is disposed in a position in the unwrapping means 14 approximately opposite the grabs 20, i.e. in approximately the middle of an underside portion of the wrapper of a deposited stack, in order to remove and dispose of the cut wrapper. The suction extraction means 50 consists substantially of a pipe socket 52, which is open at the top, with a valve 54. Downstream and not shown, there is a vacuum generating means, such as an industrial vacuum cleaner, which maintains a predetermined partial vacuum within a certain volume. When the valve 54 is opened rapidly, a periodic partial vacuum arises at the mouth of the pipe socket 52, so that the wrapper 10 is extracted abruptly.

Downstream of the unwrapping means 14 is a delivery means, which is merely indicated schematically in FIG. 1 and is designated by reference numeral 60. The delivery means has a grab to grasp the stack 8 at the unwrapping means 14 once it has been released from its wrapper, said delivery means is equipped with a means for rotating the stack about one or two axes, in order to place the stack in a predetermined orientation For this purpose, a position or orientation recognition means 70 is also provided, which, by means of a camera for example, detects certain features of the articles at a facing edge of the stack and derives from them the orientation of the stack If required, the stack is then rotated about one or two axes until the predetermined orientation is reached. After that, the stack is deposited in the predetermined orientation on a conveyor belt 80, which transports the stack of articles away for further processing.

1. A method for unpacking wrapped stacks of articles, comprising the steps of:
preparing a pallet with block-like stacks of flat articles stacked thereon in layers, each wrapped in a film-like wrapper,
locating a stack,
lowering a lifting head onto an upper side of the stack,
grasping a portion of the wrapper associated with the upper side with he lifting head, removing the stack and depositing it at an unwrapping station,
grasping and raising the portion of the wrapper with two grabs at two spaced-apart grabbing positions,
cutting through the portion of the wrapper between the grabbing positions,
opening the wrapper with the grabs,
grasping the stack while the wrapper is held tight by the grabs, and depositing the stack at a delivery position, and
removing the wrapper

2. The method as claimed in claim 1, wherein the stack is prepared in a position in which the flat articles awe arranged side by side in a vertical position.

3. The method as claimed in claim 1, wherein the grasping of the portion of the wrapper with the lifting head is effected by means of a partial vacuum and/or by means of clamping and gripping.

4. The method as claimed in claim 1, wherein the grasping of the portion of the wrapper at the unwrapping station is effected by means of a partial vacuum and/or by means of clamping and

5. The method as claimed in claim 1, wherein the portion of the wrapper is cut through by a horizontally movable cutting knife, forming two free wrapper ends in the process.

6. The method as claimed in claim 5, wherein the wrapper ends are moved apart in apposite directions with the grabs, and the wrapper is opened in this way before the stack is grasped and deposited at the delivery position.

7. The method as claimed in claim 1, wherein the wrapper is withdrawn by means of a partial vacuum and is removed from the unwrapping station.

8. The method as claimed in claim 1, wherein an orientation of the stack is detected and the stack is rotated before being deposited in a predetermined orientation.

9. A device for unpacking wrapped stacks of articles utilizing He method as claimed in claim 1, the device comprising:
a lifting means for grasping and removing a block-like stack of flat articles wrapped in a film-like wrapper from a pallet,
an unwrapping means with two separately movable grabs for grasping a portion of the wrapper at the top side of the stack at two spaced-apart grabbing positions, and having a cutting means for cutting through the portion of the wrapper between the grabbing positions, the grabs being controlled such that, after the portion of the wrapper has been grasped and cut through, they open the wrapper, and
a delivery means for gang and depositing the wrapper-free stack at a delivery position.

10. The device as claimed in claim 9, wherein the lifting means has a vacuum lifting hear

11. The device as claimed in claim 10, wherein the vacuum lifting head has a perforated plate and an elastic sealing bead running along the edge thereof.

12. The device as claimed in claim 9, wherein the lifting means has a centering means with two photoelectric barriers working in directions perpendicular to one another for locating a corner of a pallet stack.

13. The device as claimed in claim 9, wherein the grabs each have a grab body and a gripping member movable relative thereto, in order to entrain the wrapper by means of friction and to grasp and clamp it between the gripping member and the grab body.

14. The device as claimed in claim 13, wherein the gripping surface has elevated surface roughness.

15. The device as claimed in claim 13, wherein a partial vacuum can be applied to the gripping surface of the grab body and/or gripping member.

16. The device as claimed in claim 9, wherein the grabs are mounted in a floating manner about a swiveling axis.

17. The device as claimed in claim 9, wherein the grabs are capable of being swiveled in opposite directions about swiveling axes, in order to open the wrapper after it has been cut.

18. The device as claimed in claim 9, wherein the cutting means has a horizontally movable cutting knife.

19. The device as claimed in claim 9, wherein the cutting means has a cutting knife disposed pointing in an inclined manner in a withdrawal direction with a guard arm and guide rollers.

20. The device as claimed in claim 9, wherein the unwrapping means has suction extraction means for removing and disposing of the wrapper.

21. The device as claimed in claim 9, wherein the delivery means has a position recognition means for detecting the orientation of a stack and a rotating means for rotating into a predetermined orientation.
